(19) United States
(12) Patent Application Publication
(10) Pub. No.: US 2017/0011563 A1
(43) Pub. Date: Jan. 12, 2017

(54) LOW COST TIRE BUBBLE FAULT DIAGNOSIS

(71) Applicant: Continental Automotive Systems, Inc., Auburn Hills, MI (US)

(72) Inventors: Victor Hugo Huidobro Garcia, Guadalajra (MX); Juan Luis Guerrero Ruiz, Tlaquepaque (MX); Javier Iván Robles Valdivia, Guadalajara (MX); Alan Mauricio Blanco Sandoval, Zapopan (MX)

(21) Appl. No.: 14/792,693

(22) Filed: Jul. 7, 2015

(51) Int. Cl. G07C 5/08; G01M 17/02

(52) U.S. Cl. CPC G07C 5/08; G01M 17/02

(57) ABSTRACT

A discloses system and method utilizes sensed oscillatory characteristics of a vehicle to detect a defect within a tire. The system utilizes information from sensors that are not disposed within a vehicle tire to detect tire defects. Information of oscillatory characteristics of the vehicle are analyzed to determine if the vehicle is operating as expected, or if a defect on the tire has changed the expected characteristics. Once a determination is made that a defect is present, an alert signal can be initiated to alert an operator that corrective action is required.

### BACKGROUND

This disclosure generally relates to a system and method for detecting defects within a vehicle tire during vehicle operation. More particularly, this disclosure relates to a system and method for detecting a tire defect without sensors mounted within a vehicle tire.

Tire pressure monitoring systems and sensors are utilized to provide information indicative of conditions within vehicle tire to a vehicle operator. A sensor mounted within each of the vehicle wheels provides information such as pressure and temperature that is communicated to a vehicle operator. However, such systems are not intended for detecting tire defects that do not change tire pressure and temperature. Such tire defects can include tire deformations such as a tire bubble. A tire bubble is an outgrowth on a tire that is within a tire contact patch and is indicative of a potential failure of the tire. It is therefore desirable to detect such defects and provide information to a vehicle operator indicative of the tire defect to prompt corrective action.

### SUMMARY

A system and method of detecting defects of a tire mounted on a vehicle utilizes information gathered relating to expected oscillatory characteristics of a vehicle. If the oscillatory characteristics are not as expected for tires within predetermined operational parameter, a determination can be made to alert a vehicle operator that a defect within one of the tires may be present.

The system utilizes sensors mounted throughout the vehicle and outside of the inner cavity of a tire. The sensors provide information indicative of an oscillatory characteristic of the vehicle. A controller compares the sensed oscillatory characteristic of the vehicle with predefined oscillatory characteristic indicative of a defect in at least one of the vehicle tires. The comparison is utilized to determine if at least one of the vehicle tires such that in response a measured signal being indicative of a defect in at least one of the vehicle tires an alert signal can be initiated to inform the vehicle operator.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic drawing of a vehicle including an example tire defect detection system.

FIG. 2 is an enlarged view of an example tire including a defect.

FIG. 3 is a schematic free body diagram of an example vehicle including the example system for detecting tire defects.

FIG. 4 is a schematic free body diagram of a suspension component a motor vehicle.

FIG. 5 is a schematic view of an example controller and system for detecting tire defects.

FIG. 6 is a flow diagram of an example method for detecting tire defects.

### DETAILED DESCRIPTION

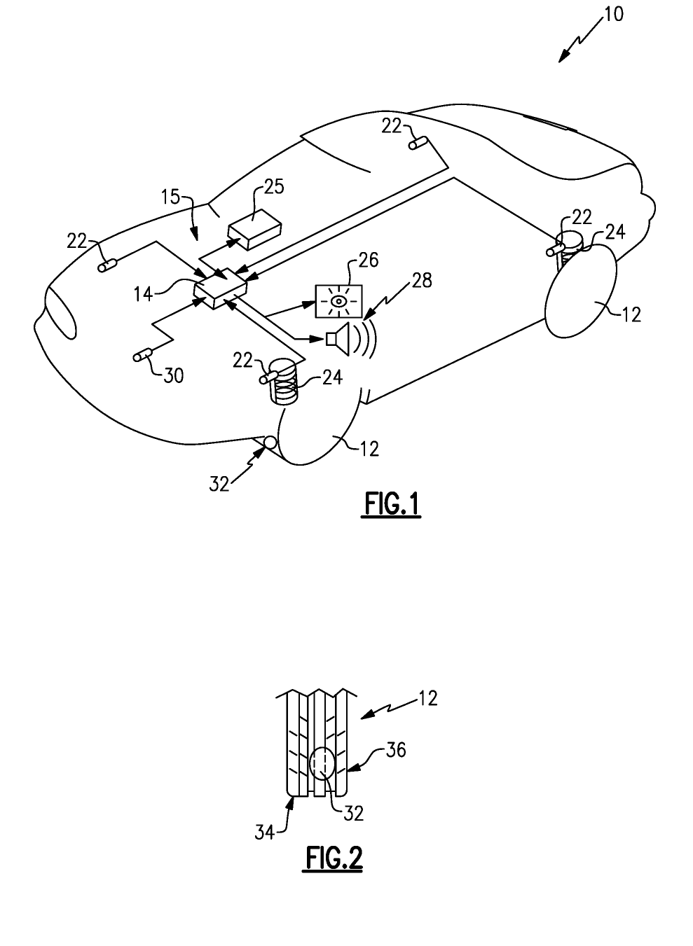

Referring to FIG. 1, a vehicle 10 includes a system 15 for detecting a defect or fault in one of several tires 12. The example system 15 includes a controller 14 that receives information from acceleration sensors 22 mounted within the vehicle for detecting a defect 32 in one of the tires 12.

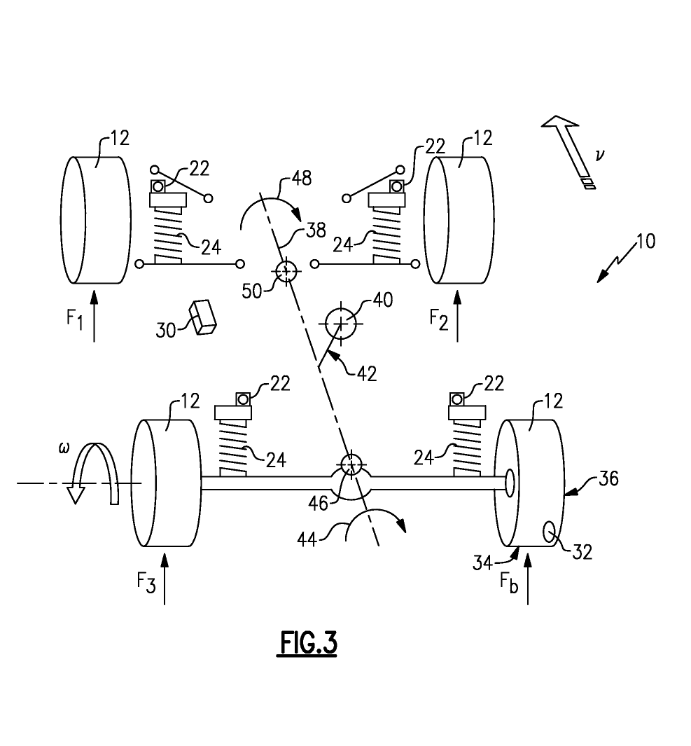

Referring to FIG. 2 with continued reference to FIG. 1, each tire 12 includes a sidewall 36 and a tread side 34 that is in contact with the road surface. The presence of a defect 32 on the tread side 34 creates recognizable oscillatory characteristics utilized to indicate the presence of a defect. The system 15 provides for detection of a defect 32 such that a vehicle operator can be alerted to take corrective action if necessary.

In this example, the sensors are acceleration sensors 22 mounted to suspension components 24 of the motor vehicle. Each of the sensors 22 generates information indicative of oscillatory characteristics of each component and thereby of the vehicle 10. Another sensor 30 is mounted to the body in addition to those mounted within a suspension component. Each of the sensors 22 and 30 are mounted to specific portions of the vehicle that are not within the rotating portions of the tires 12. The example disclosed sensors 22 and 30 are accelerometer sensors that provide information indicative of oscillatory characteristics encountered by the vehicle and specific components of the vehicle.

The controller 14 receives information from the various sensors 22 mounted within the vehicle and utilizes that information to determine if a defect 32 is present within one of the tires 12. In response to the detection of a defect 32 and/or conditions that are recognized to be indicative of a defect within the tire 12, a signal is sent to an alert device such a display 26 or speaker 28 disposed within the vehicle cabin to alert the operator that the tires need attention.

Referring to FIG. 3, the example vehicle 12 is shown schematically as a free body diagram. Each of the suspension components 24 includes a sensor 22 that is utilized to measure and generate a signal indicative of the oscillations of that specific suspension component 24. The sensors 22 thereby provide information indicative of all dynamic aspects and functions of the vehicle.

In this example, forces on the vehicle can induce moments about the main longitudinal axis 38 in roll directions indicated by arrows 48 and 44. In this example, arrow 44 represents a forward roll about a forward location 46 on the longitudinal axis 38. The arrow 48 is indicative of roll about an aft location 50 on the longitudinal axis. All of the components rotate relative to the vehicle center of gravity 40 is disposed a distance away from the longitudinal axis 38 as indicated by the moment arm 42.

During operation of the vehicle, each of the tires 12 encounters a force indicated by F1, F2, F3 and FB. This force along with the features of the suspension component 24 contributes to an oscillatory characteristic of the vehicle. When a tire 12 includes a defect as is indicated at 32, that defect will disrupt and generate a specific oscillatory characteristic unique to the defect 32 found on the tread side 34 of the tire 12. Because the sensors 22 and 30 provide information that is indicative of oscillatory characteristics of the vehicle, this defect and the tire 12 will be detected by a corresponding sensor 22 that corresponds to the suspension component 24 to the wheel 12. Moreover, the overall oscillatory characteristic is a function of the forces F1, F2, F3 and FB, such that the overall vehicle oscillatory characteristic is significantly changed in response to the defect 32 formed on the tread side 34 of the tire 12.

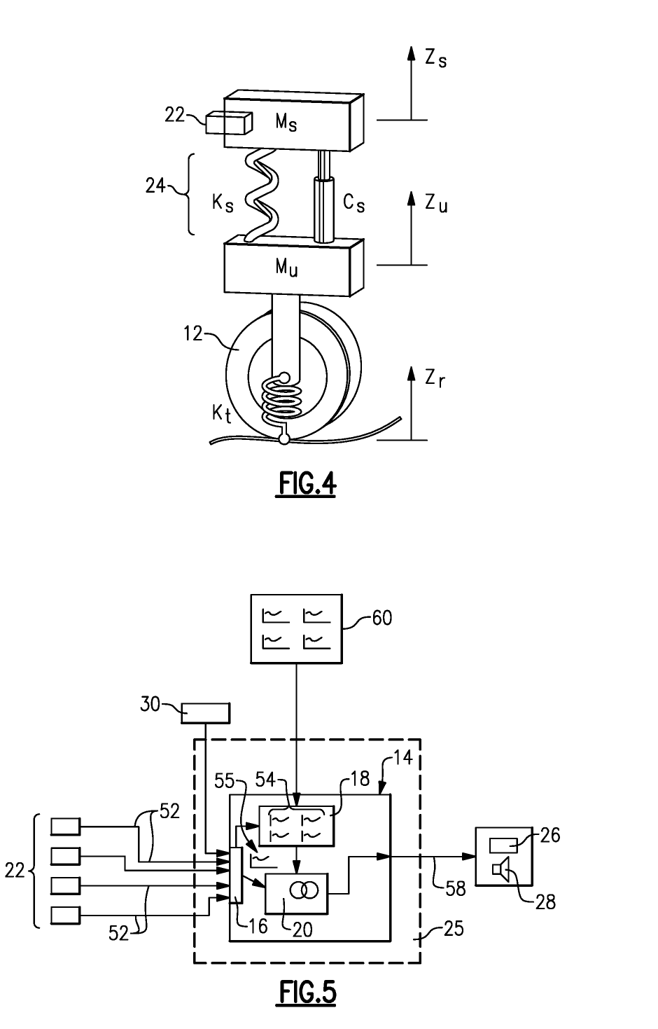

Referring to FIG. 4 with continued reference to FIG. 3, a single wheel 12 is illustrated in a schematic free body diagram including each of the suspension components 24 that contribute to the overall oscillatory characteristic of a specific wheel 12 within the vehicle 10. Each portion of a vehicle suspension contributes a certain oscillatory effect to provide a known oscillatory condition and characteristic for each of the vehicle suspension components and thereby the entire overall vehicle 10. It is this characteristic that is utilized to detect a tire defect within one of the vehicle tires 12.

Referring to FIG. 5 with continued reference to FIG. 3, the example system 15 is schematically illustrated and includes a controller 14. In this example, the controller 14 is shown as a standalone controller 14 however, the controller 14 may also be part of a larger total vehicle controller.

The controller 14 includes a first portion 16 for receiving signals 52 from the various acceleration sensors 22. The first portion 16 communicates those signals 52 to a second portion 18. The second portion 18 includes a plurality of known oscillatory vehicle characteristics 54. This plurality of oscillatory characteristics 54 are loaded into the second portion 18 of the controller 14 prior to operation of the vehicle. The plurality of known oscillatory characteristics are from predetermined tests on the vehicle or through other means to define a plurality of oscillatory vibrations or characteristics of the vehicle that are indicative of normal operation and are also indicative of known defects within a vehicle tire 12. The predefined oscillatory characteristics 60 are preloaded into the second portion of the controller 18.

The controller 18 thereby provides for comparison between measured oscillatory characteristics provided through the signals 52 and then compared with the plurality of oscillatory characteristics 54 stored in the second portion 18 of the controller 14.

The controller includes a third portion 20 that compares the measured oscillatory characteristic (schematically indicated at 55) with the preloaded and predetermined oscillatory characteristics to determine if any of the predetermined oscillatory characteristics correspond and match, within a desired tolerance, with the actual measured oscillatory characteristics measured by the sensors 22.

If the comparison between the measured oscillatory characteristic 55 matches or corresponds with one of the predefined oscillatory characteristics 60 that are indicative of a tire defect, the controller 14 can generate a signal 58 that goes to an alert device such the display 26 or speaker 28 disposed within the vehicle cabin. The alert device provides a warning for the driver that at least one of the tires includes a defect that will require attention. This early warning provides a driver and opportunity to take corrective.

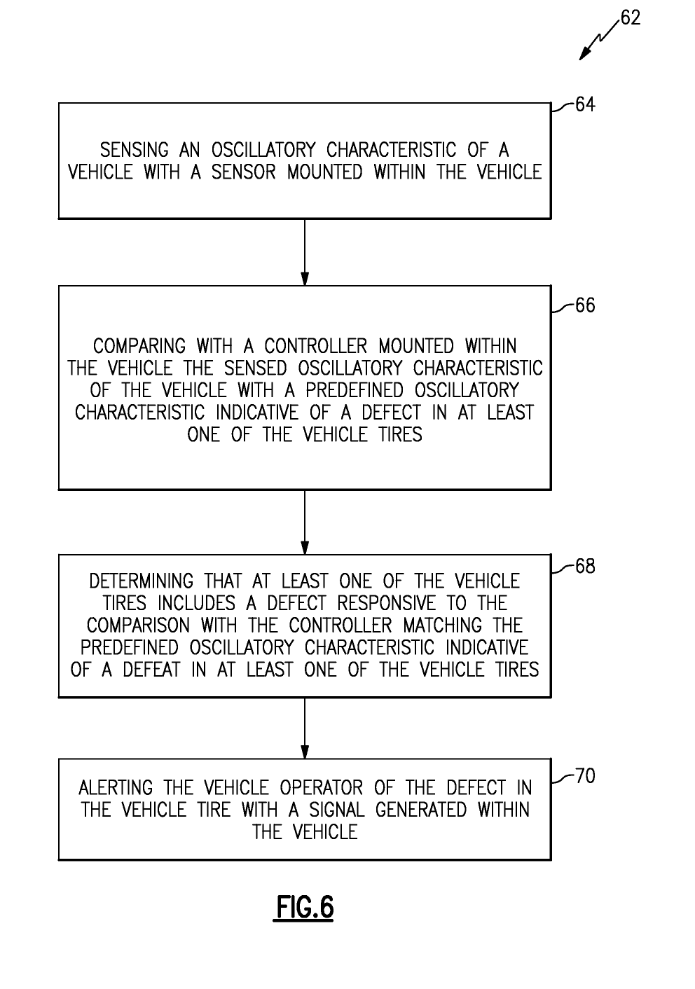

Referring to FIG. 6, with reference to FIGS. 1 and 3, a disclosed example method is schematically shown at 62 and includes a first step 64 of measuring an oscillatory characteristic of the vehicle 10 with sensors 22 mounted throughout the vehicle 10. Each of the sensors 22 and 30 are mounted on portions of the vehicle that are not rotating and are not within the tire 12.

It should be appreciated that it is known in the art to install a tire pressure monitoring device within a tire to obtain information indicative to tire pressure and temperature. However, such sensors are not capable of providing information concerning tire defects as is provided by the example system 15.

The example controller includes a preloaded set of known oscillatory characteristics 60 (FIG. 5) that are indicative of normal vehicle operation conditions and also are indicative of a defect in one of the vehicle's tires. Accordingly, the controller 14 will include a plurality of known oscillatory characteristics 60 that are each indicative of a different vehicle operating parameter. In some instances, all the predefined and preloaded oscillatory characteristics 60 stored within the controller 14 will be indicative of normal operating conditions of the vehicle. In this case, a failure of the actual measured oscillatory characteristics of the vehicle to correspond with one of the predefined and stored characteristics within the controller 14 will result in the controller 14 making a determination that there is a defect within one of the vehicle tires 12.

Alternatively, the predefined oscillatory characteristics 60 can all be indicative of a tire defect condition. In this instance, a match between the measured actual oscillatory characteristic 55 (FIG. 5) of the vehicle with a predefined oscillatory characteristic 60 within the controller 14 will result in the determination that one of the vehicle tires includes a defect. The controller 14 uses the stored characteristics 60 to compare with the measured characteristics 55 as is schematically indicated at 66.

The controller 14 will then make a determination as is schematically indicated at 68. Upon the controller 14 making a determination that at least one of the vehicle tires includes a tire defect 32, the controller 14 will initiate an alert activity, schematically indicated at 70, to provide and communicate with the vehicle operator that at least one of the tires 12 requires services and examination. In this example, the alert includes a display device 26 that will display an icon or may utilize a speaker 28 disposed within the vehicle cabin to emit an audible warning that requires operator action.

Accordingly, the example system 15 provides for the detection of tire defects without utilizing sensors installed within the rotating components. Moreover, the example system 15 utilizes accelerometers and other sensors 22 already utilized within the vehicle such that additional hardware may not be required.

Although an example embodiment has been disclosed, a worker of ordinary skill in this art would recognize that certain modifications would come within the scope of this disclosure. For that reason, the following claims should be studied to determine the scope and content of this disclosure.

1. A method of detecting defects of a tire mounted on a vehicle comprising:
sensing an oscillatory characteristic of a vehicle with a sensor mounted within the vehicle;
storing a plurality of predefines oscillatory characteristics indicative of known vehicle operating parameters including a predefined oscillatory characteristics indicative of both normal operating conditions and a range of tire defects;
comparing with a controller mounted within the vehicle the sensed oscillatory characteristic of the vehicle with stored predefined oscillatory characteristics indicative of a defect in at least one of the vehicle tires; and
determining that at least one of the vehicle tires includes a defect responsive to the comparison with the controller matching the predefined oscillatory characteristic indicative of a defect in at least one of the vehicle tires.

2. The method as recited in claim 1, wherein the sensor comprises an accelerometer attached to a suspension component of the vehicle for sensing vibration of the suspension component.

3. The method as recited in claim 2, wherein the accelerometer senses a frequency of vibration within the suspension component.

4. The method as recited in claim 1, wherein the tire defect comprises a protrusion on a tread side of the vehicle tire and the sensor measures a vibration induced by the protrusion during rotation of the tire.

5. The method as recited in claim 4, wherein the vibration induces a force on the vehicle that creates a frequency that is identified by the controller with the data provided by the sensor.

6. (canceled)

7. The method as recited in claim 1, including mounting the sensor to a vehicle component outside of the vehicle tire.

8. The method as recited in claim 1, including alerting the vehicle operator of the defect in the vehicle tire with a signal generated within the vehicle.

9. A tire monitoring system for a motor vehicle comprising:
a controller including:
a first portion receiving information from a sensor indicative of an oscillatory characteristic of a vehicle;
a second portion comparing the sensed oscillatory characteristic of the vehicle with a predefined oscillatory characteristic indicative of a defect in at least one of the vehicle tires, wherein the predefined oscillatory characteristic comprises a plurality of predefined oscillatory characteristic indicative of both normal operating conditions and a range of tire defects; and
a third portion determining that at least one of the vehicle tires includes a defect responsive to the comparison matching the predefined oscillatory characteristic indicative of a defect in at least one of the vehicle tires.

10. The tire monitoring system as recited in claim 9, including a sensor mounted to a suspension component of the vehicle outside of the vehicle tire.

11. The tire monitoring system as recited in claim 9, including a sensor mounted to a portion of the vehicle body that is outside of the vehicle tire.

12. The tire monitoring system as recited in claim 9, wherein the sensor comprises at least one accelerometer communicating information indicative of an oscillatory characteristic of a vehicle component.

13. The tire monitoring system as recited in claim 9, including a plurality of sensors mounted within the vehicle communicating data indicative of an oscillatory characteristic of a vehicle component to the controller.

14. (canceled)

15. The tire monitoring system as recited in claim 9, wherein the controller comprises a stand-alone controller in communication with a vehicle control module.

16. The tire monitoring system as recited in claim 9, wherein the controller comprises a portion of a vehicle control module.
